(19) United States
(12) Patent Application Publication
(10) Pub. No.: US 2013/0293982 A1
(43) Pub. Date: Nov. 7, 2013

(54) DISK DRIVE EMPLOYING SINGLE POLARITY SUPPLY VOLTAGE TO GENERATE WRITE CURRENT

(71) Applicant: WILLIAM D. HUBER, HOLLISTER, CA (US)

(72) Inventor: WILLIAM D. HUBER, HOLLISTER, CA (US)

(73) Assignee: WESTERN DIGITAL TECHNOLOGIES, INC., Irvine, CA (US)

(21) Appl. No.: 13/462,626

(22) Filed: May 2, 2012

(51) Int. Cl. G11B 5/02

(52) U.S. Cl. 360/68; G9B/5.026

(57) ABSTRACT

A disk drive is disclosed comprising a disk, an actuator arm comprising a suspension, and a head coupled to a distal end of the suspension, wherein the head comprises a write coil. The disk drive further comprises a preamp operable to generate a write current applied to the write coil in response to a single polarity supply voltage which may be positive or negative. In one embodiment, the transmission lines that couple the write coil to the suspension comprise respective, parallel plate sections that form a capacitance which enables driving the preamp with the single polarity supply voltage.

### BACKGROUND

The head in a disk drive is typically mounted on a slider attached to the end of a suspension. The suspension is attached to a distal end of an actuator arm which is rotated about a pivot by a voice coil motor (VCM) in order to actuate the head radially over the disk. The suspension is fabricated with traces (e.g., copper traces) which act as transmission lines that carry the write/read signals between the head and a preamp. Prior art write driver preamps are driven with positive and negative supply voltages to achieve a rail-to-rail voltage having sufficient magnitude to generate a correspondingly adequate write current.

### BRIEF DESCRIPTION OF THE DRAWINGS

FIG. 1A shows a disk drive according to an embodiment of the present invention comprising a head actuated over a disk.

FIG. 1B shows a single polarity preamp operable to drive a write coil of a head mounted to a distal end of a suspension according to an embodiment of the present invention.

FIG. 2 shows details of a head comprising a write coil according to an embodiment of the present invention.

FIG. 3 shows the transmission lines coupling the write coil to traces mounted on the suspension, wherein the transmission lines comprise an integrated capacitor in the form of parallel top and bottom plate sections according to an embodiment of the present invention.

FIG. 4 is an exploded view showing the transmission lines of the write coil including the top and bottom plate sections that form the capacitor according to an embodiment of the present invention.

FIG. 5 shows a magnified view of the transmission lines of the write coil including the top and bottom plates that form the capacitor according to an embodiment of the present invention.

FIG. 6 shows an embodiment of the present invention wherein the capacitor fabricated into the transmission lines of the head/suspension interconnect is part of an inductor/capacitor ladder network formed by other inductors and capacitors fabricated into the transmission lines that connect the head to the preamp.

FIG. 7 shows a frequency response (group delay and magnitude) of the inductor/capacitor ladder network fabricated into the transmission lines according to an embodiment of the present invention.

### DETAILED DESCRIPTION OF EMBODIMENTS OF THE INVENTION

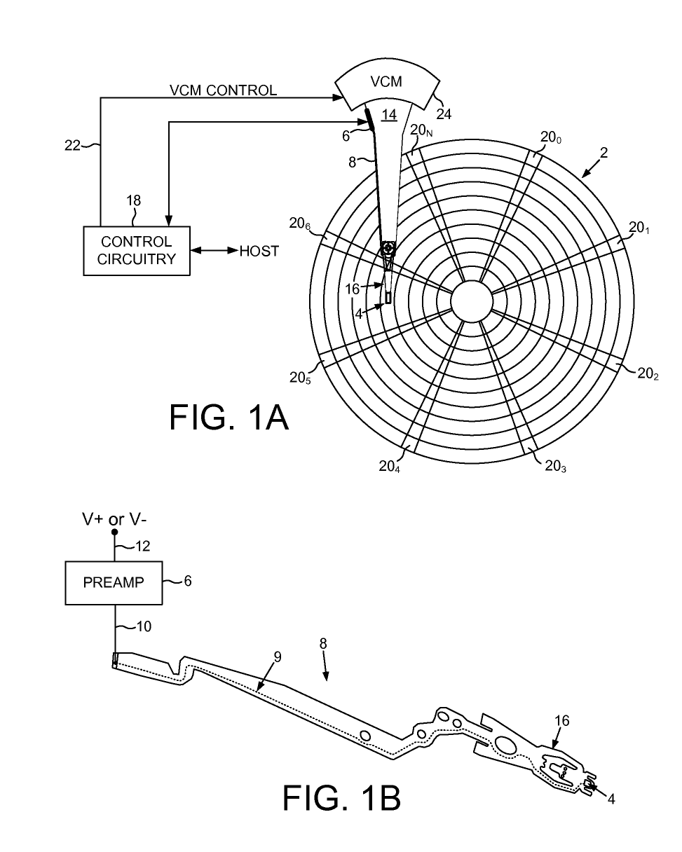

FIGS. 1A and 1B show a disk drive according to an embodiment of the present invention comprising a disk 2, a head 4 actuated over the disk 2, a preamp 6, and an interconnect 8 for coupling the head 4 to the preamp 6. The head 4 comprises a write coil, and the preamp 6 is operable to generate a write current 10 applied to the write coil in response to a single polarity supply voltage 12.

In the embodiment of FIG. 1A, the head 4 is coupled to a distal end of an actuator arm 14 by a suspension 16 that biases the head 4 toward the surface of the disk 2. As the disk 2 spins, an air bearing forms between the head 4 and disk surface such that the head 4 is said to “fly” over the disk surface. Control circuitry 18 generates a write current applied to the head 4 through the preamp 6 during write operations, and during read operations demodulates a read signal emanating from the head 4 through the preamp 6. The control circuitry 18 may demodulate embedded servo sectors 20₀-20_{N} recorded around the circumference of the disk 2 in order to generate a VCM control signal 22 applied to a voice coil motor (VCM) 24 which rotates the actuator arm 14 about a pivot in order to position the head 4 radially over the disk 2.

Any suitable head 4 may be employed in the embodiments of the present invention, such as a head 4 comprising an inductive write element (write coil) and a magnetoresistive (MR) read element. A write operation is performed by modulating a write current emanating from the preamp 6 and passing through the transmission lines and through the write coil in order to write magnetic transitions onto the disk surface. During a read operation, the read element senses the magnetic transitions to generate a read signal carried by transmission lines to the preamp 6.

Prior art write driver preamps are driven with a positive and negative supply voltage to achieve a rail-to-rail voltage having sufficient magnitude to generate a correspondingly adequate write current. This increases the cost of the preamp as well as the power consumption which is undesirable, particularly in portable applications. In one embodiment of the present invention, the writing power is reduced without reducing the write current level by lowering the impedance between the head and the preamp. This enables the use of a preamp 6 driven with a single polarity supply voltage 12 as shown in FIG. 1B, wherein the single polarity supply voltage 12 may be positive or negative.

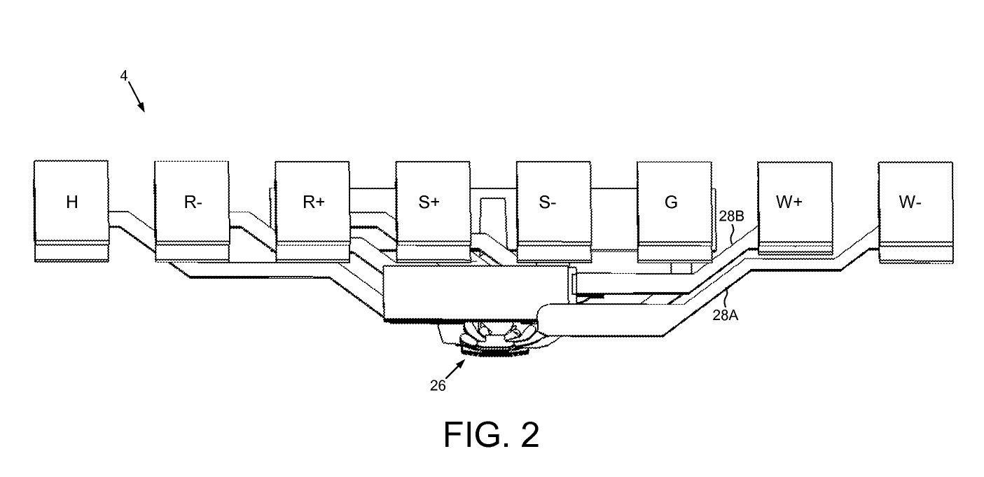

FIG. 2 shows details of a head 4 according to an embodiment of the present invention comprising a plurality of pads operable to couple various components of the head to the suspension 16 through low impedance transmission lines. For example, in the embodiment shown the pads include a heater pad (H), read signal pads (R−,R+), fly height sensor pads (S+,S−), a ground pad (G), and write signal pads (W+,W−). The write signal pads (W+,W−) connect to the write coil 26 of the head 4 through first and second transmission lines 28A and 28B.

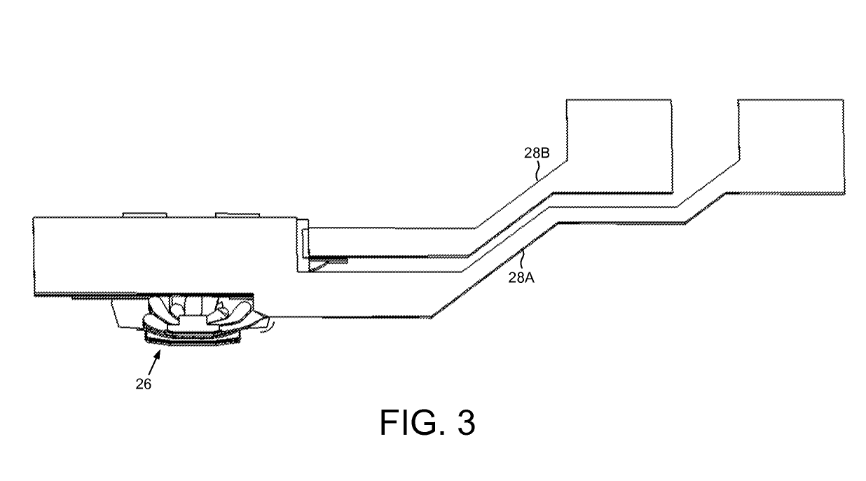

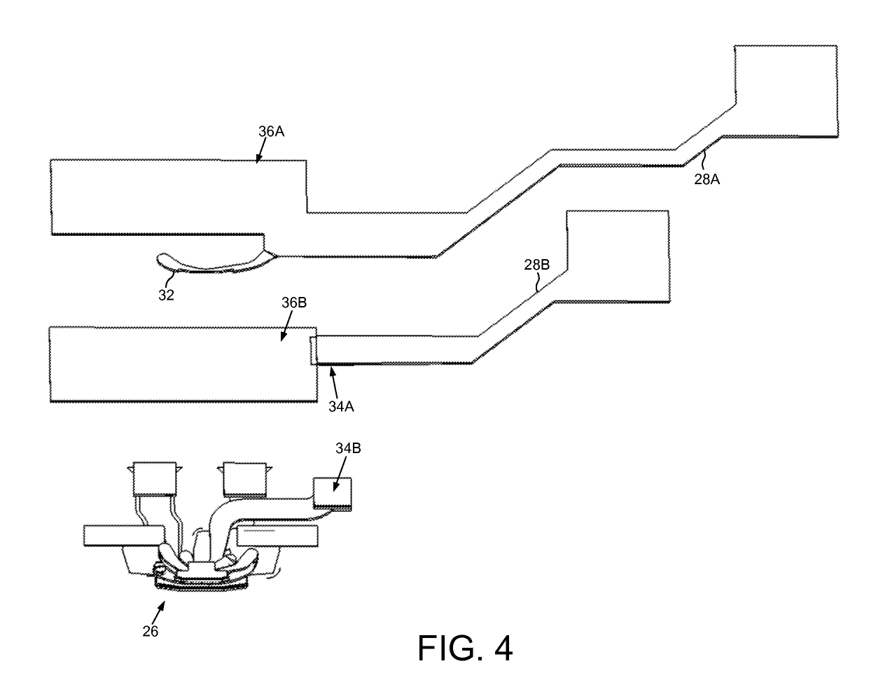

In one embodiment after lowering the impedance of the transmission lines connecting the preamp 6 to the head 4, the bandwidth between the head 4 and the preamp 6 is maximized by fabricating a capacitance in the first and second transmission lines 28A and 28B that couple the write coil 26 to the suspension 16 (through pads (W+,W−)). FIG. 3 shows details of the write path for the head 4, and FIG. 4 shows an exploded view of the write path elements including the first transmission line 28A and the second transmission line 28B. The first transmission line 28A connects to a first end of the write coil 26 through a conducting element 32 (which may be part of the write coil), and the second transmission line 28B connects to a second end of the write coil 26 through contact tabs 34A and 34B. The first transmission line 28A comprises a first plate section 36A that is positioned over a second plate section 36B of the second transmission line 28B to form a capacitance that is connected in parallel with the write coil 26.

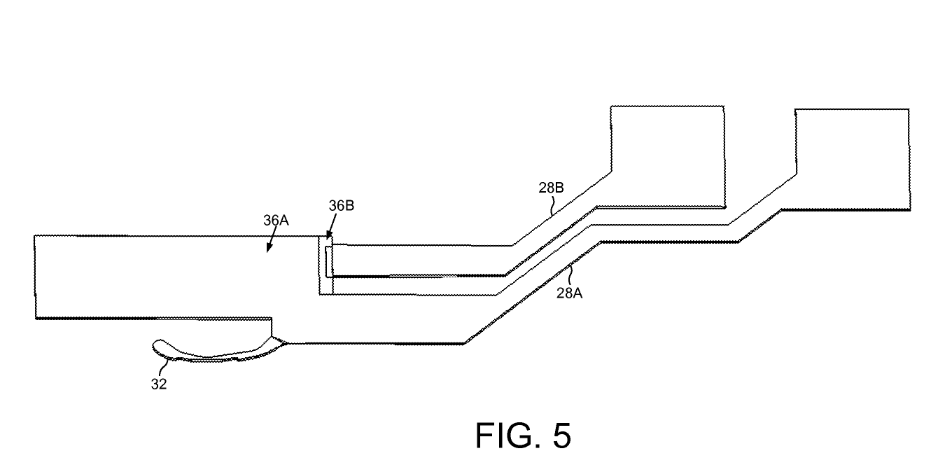

FIG. 5 shows a magnified view of just the first and second transmission lines 28A and 28B, including the first plate section 36A positioned over the second plate section 36B to form the capacitance. In the embodiment of FIG. 5, the first and second transmission lines 28A and 28B are fabricated very near the same plane, with the second, bottom transmission line 28B offset vertically from the first, top transmission line 28A by a small delta, thereby forming a gap between the first plate section 36A and the second plate section 36B. The gap between the plate sections forms the dielectric gap between the plates of the capacitor. The dielectric may be air, or any other suitable dielectric, such as alumina.

The transmission lines 28A and 28B, including the first and second plate sections 36A and 36B, may comprise any suitable conductive material, such as a conductive metal (e.g., copper). Any suitable technique may be employed to fabricate the transmission lines 28A and 28B, such as with any suitable etching or deposition technique.

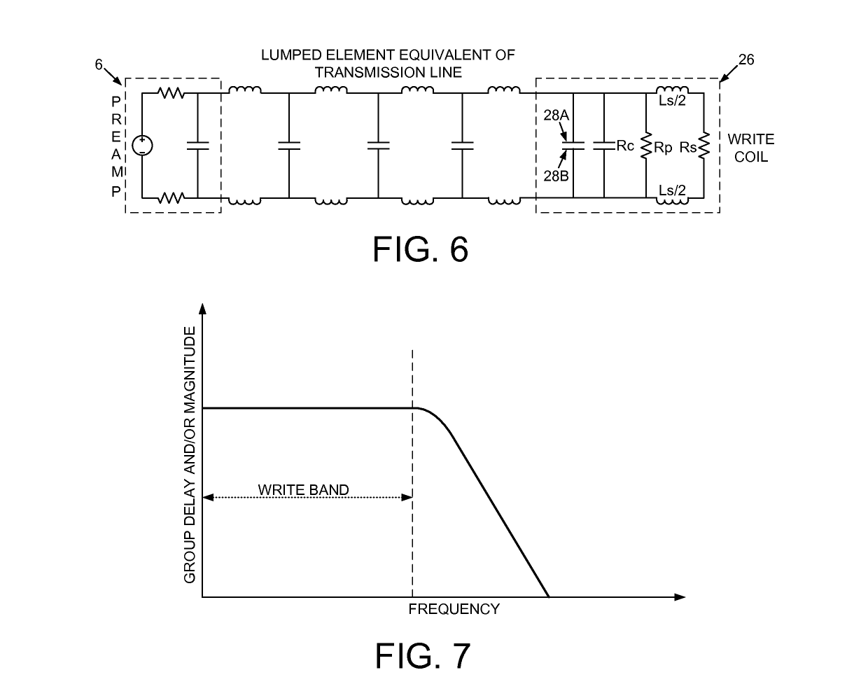

In one embodiment, the capacitor formed by the first and second plate sections 36A and 36B and fabricated with the head 4 are part of an approximated inductor/capacitor ladder network shown in FIG. 6, wherein the other inductors and capacitors of the ladder network are formed by providing suitable transmission lines 9 that extend along the interconnect 8 (FIG. 1B). The transmission lines 9 in one embodiment comprises first and second edge coupled or broadside coupled transmission lines fabricated with predetermined widths, lengths, and separations to form the remaining inductors and capacitors of the inductor/capacitor ladder network shown in FIG. 6. In one embodiment, the transmission lines 9 are fabricated such that the approximated inductor/capacitor ladder network helps to flatten a magnitude and delay response over the widest possible bandwidth in conjunction with the added capacitance in parallel with the writer coil through the interconnect 8 (including the transmission lines connecting the head 4 to the suspension 16) over a frequency band of the write signal as shown in FIG. 7. This is not a conjugate match is the sense of transferring maximum power rather it is shaping the signal path to exhibit a flat delay transfer function over maximum bandwidth to preserve signal integrity.

What is claimed is:

1. A disk drive comprising:
a disk;
an actuator arm comprising a suspension;
a head coupled to a distal end of the suspension, the head comprising a write coil; and
a preamp operable to generate a write current applied to the write coil in response to a single polarity supply voltage.

2. The disk drive as recited in claim 1, further comprising a capacitance connected in parallel with the write coil.

3. The disk drive as recited in claim 2, further comprising:
a first transmission line coupling a first end of the write coil to the suspension; and
a second transmission line coupling a second end of the write coil to the suspension,
wherein the first transmission line comprises a first plate section and the second transmission line comprises a second plate section positioned over the first plate section to form the capacitance.

4. The disk drive as recited in claim 2, wherein the single polarity supply voltage comprises a positive voltage.

5. The disk drive as recited in claim 2, wherein the single polarity supply voltage comprises a negative voltage.

6. A method of operating a disk drive, the disk drive comprising a disk, an actuator arm comprising a suspension, and a head coupled to a distal end of the suspension, the head comprising a write coil, the method comprising:
using a preamp to generate a write current applied to the write coil in response to a single polarity supply voltage.

7. The method as recited in claim 6, wherein a capacitance is connected in parallel with the write coil.

8. The method as recited in claim 7, wherein the disk drive further comprises:
a first transmission line coupling a first end of the write coil to the suspension; and
a second transmission line coupling a second end of the write coil to the suspension,
wherein the first transmission line comprises a first plate section and the second transmission line comprises a second plate section positioned over the first plate section to form the capacitance.

9. The method as recited in claim 7, wherein the single polarity supply voltage comprises a positive voltage.

10. The method as recited in claim 7, wherein the single polarity supply voltage comprises a negative voltage.

11. A disk drive comprising:
a disk;
an actuator arm comprising a suspension;
a head coupled to a distal end of the suspension, the head comprising a write coil;
a first transmission line coupling a first end of the write coil to the suspension; and
a second transmission line coupling a second end of the write coil to the suspension,
wherein the first transmission line comprises a first plate section and the second transmission line comprises a second plate section positioned over the first plate section to form a capacitance.

12. A head for use in a disk drive, the head comprising:
a write coil;
a first transmission line operable to couple a first end of the write coil to a suspension; and
a second transmission line operable to couple a second end of the write coil to the suspension,
wherein the first transmission line comprises a first plate section and the second transmission line comprises a second plate section positioned over the first plate section to form a capacitance.
